(19) United States
(12) Patent Application Publication
(10) Pub. No.: US 2026/0003857 A1
(43) Pub. Date: Jan. 1, 2026

(54) MAINTAINING A CONFIGURABLE LEVEL OF TRANSACTION CONSISTENCY WHEN USING DATABASE REPLICATION THROUGH A CONTENT FILTER

(71) Applicant: Oracle International Corporation, Redwood Shores, CA (US)

(72) Inventors: Jagdev Dhillon, Menlo Park, CA (US); Yoshitaka Baba, Melrose, MA (US); Jeffrey Pollock, Cary, NC (US); Nicholas Ratanasin, McKinney, TX (US); Matthew Scott Piermarini, Edgewater, MD (US)

(21) Appl. No.: 18/759,850

(22) Filed: Jun. 29, 2024

(51) Int. Cl. G06F 16/23; G06F 16/27

(52) U.S. Cl. CPC G06F 16/2379; G06F 16/27

(57) ABSTRACT

Here is database replication that, for consistency and security, is based on an innovative unidirectional gateway that modifies and annotates a sequence of human-readable database transaction files. On a communication network, the unidirectional gateway receives a batch of change entries in a database transaction extensible markup language (XML) file. The unidirectional gateway modifies change entry(s). The unidirectional gateway generates and inserts, into the database transaction XML file, metadata that describes the modifications of the change entries. The modified database transaction XML file is converted into a binary file format that for a downstream database and, before or after that conversion, downstream processing of the database transaction file is based on the metadata that describes the modifications of the change entries.

### FIELD OF THE DISCLOSURE

This disclosure relates to database replication. For consistency and security, herein is a unidirectional gateway that modifies and annotates a sequence of human-readable database transaction files.

### BACKGROUND

Organizations may at times need to move, copy, or otherwise replicate data between different database environments, for example to create a backup of a database, or to enable sharing of the data between different database applications or different organizations. Other examples of data replication include: a) high availability (HA) and disaster recovery (DR) and b) locality of data to improve data access for data consumers. Change data capture systems help address data synchronization needs, for example by detecting and replicating changes to database content, which might be made to a database table as a result of database transactions such as row operations, rather than copying the entire table and its data. Such an approach can be used, for example, to synchronize data in a source database with that in a target database.

In some data replication environments, a change data capture system can operate by reading a record of database transactions from transaction log files, and using that in replicating data, or modifications to a database, between source and target servers. However, such an approach generally requires the capture process to know the location of, and be able to directly access, the transaction log files stored locally. If, for example, a source database server is running on a different computer from the capture process, or on a different network, or within an access-restricted environment such as a cloud environment, then the capture process may not be able to access the transaction log files. The lack of a remote transaction processing ability may restrict the use of change data capture or data replication in such environments.

Database replication or synchronization may entail a source database and a target database. The above technologic challenges are heightened when information privacy and information security are concerns. In one example, regulatory compliance may forbid propagation of personally identifiable information (PII) from the source database to the target database. In another example, the source database and the target database respectively reside in a source network and a target network, and the target network should never reveal internal information to the source network. State of the art database replication and synchronization do not address these privacy and security concerns. Thus, the reliability (i.e. privacy and security) of an involved computer system may be decreased. In one example, leakage (i.e. inadvertent transmission) of sensitive information is objectively observed as a binary occurrence of a leak or no leak. In another example, leakage of sensitive information is quantitatively measured as a count of bytes, data field values, records, or files that are leaked. In those ways, unreliability of a state of the art computer may be measured, and that measured unreliability is an empirical decrease in the performance of the computer itself.

Beyond privacy, another challenge for the state of the art is transactional consistency when reconciling a version of stored data with a version of data incoming from an external system through a firewall that performs content filtering for security. Critical data can be changed or removed by a content filter. Filtration may cause a database to become inconsistent, especially if ingestion by the database is unaware that filtration occurred. For example, the state of the art may inaccurately presume: a) filtration did not occur and b) ingested data is identical to what an external source originally transmitted. Thus, state of the art security may decrease data integrity.

### BRIEF DESCRIPTION OF THE DRAWINGS

In the drawings:

FIG. 1 is a block diagram that depicts an example distributed system that contains a unidirectional gateway that modifies and annotates a sequence of database transaction extensible markup language (XML) files that are received from a communication network;

FIG. 2 is a flow diagram that depicts an example high security process for database replication;

FIG. 3 is a block diagram that illustrates a computer system upon which an embodiment of the invention may be implemented;

FIG. 4 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Here is database replication that, for consistency and security, is based on an innovative unidirectional gateway that modifies and annotates a sequence of database transaction files containing data formatted in human-readable format, such as hierarchically marked-up records or records that contain key-value pairs. A unidirectional gateway is a network gateway that may, for example, be implemented with a virtual air gap as discussed herein. An air gap is a more or less impermeable barrier to information transmission. A unidirectional air gap permits data reception but not data transmission. For various use case requirements discussed below, an enterprise may need to filter or modify transactions during the replication process. For example, in an air-gapped network, replication data has to be transmitted across a unidirectional air gap. An air gap is a (e.g. physical) barrier that entirely prevents data transmission. A unidirectional air gap prevents data transmission in one direction but permits transmission in the opposite direction. In addition to transmission, the replication data may need verification and filtering to ensure that malicious or sensitive data is not transferred from one side of the air gap to the other. A mechanism for transferring data in one direction and inspecting and cleansing the data may be referred to herein as a data diode guard. A state of the art air gap may entail a manual process to transfer, inspect, and cleanse data in a way that is not amenable to near-real time database replication between a source database and a target database in a manner that maintains transaction consistency.

The approach herein provides a configurable degree of transaction consistency when using database replication through a content filter such as for security, data cleansing, and standardization such as into a canonical representation. This approach includes detection and handling of filtered transaction records. In an embodiment, only file-based mechanisms are used for any communication between source and target databases. Transaction records are encoded in a semi-structured text file, while binary components of database transactions, such as large objects (LOBs) and file attachments, are extracted from each transaction record and transferred as separate additional individual files. Error-checking code is embedded at each hierarchical level in the semi-structured file to facilitate targeted, granular detection of content filtering. This granular detection is translated, based on configurable policies, to database actions on the target database. This approach preserves a configurable expected degree of transaction consistency between source and target databases.

Transaction records may be natively persisted in a binary file that this approach converts to, for example, an extensible markup language (XML) text file for customizable security analysis and filtration. After security processing, the XML file is converted back into a binary file for use downstream. As a streamlined and seamless delivery conduit, this approach is suitable for near real-time transactional replication. The binary file format is not human readable, but this binary format never passes through the unidirectional gateway. Only the human-readable text format such as XML is relayed through the unidirectional gateway. Thus all content transferred into the target network through the unidirectional gateway can readily be optionally manually inspected.

Control information is also generated to inform a content filter that the XML file, along with any externalized LOBs, is ready to be consumed. As a content filtering system, this approach can filter data at the entire file level, record level, and column level, or even deliver data out of order to a downstream process. The content filter system can modify metadata such as attributes or generate and insert additional control information into the filtered data such as specifications of additional actions into the transaction file as necessary for user-defined transactional consistency on the target datastore, which may be a relational or non-relational database, a Hadoop filesystem, or a continuous or batched stream that is structured such as Apache Kafka or Apache Storm that are open source.

This approach has the following innovations. Bidirectional transcoding between binary and text formats of transactional changes recorded from data manipulation language (DML) and data definition language (DDL) provides increased visibility into the database replication stream itself. Thorough syntactic and, for example, semantic validation of the database replication stream is facilitated by an XML schema mechanism such as XML schema definition (XSD). XSD, custom logic, or extensible stylesheet language (XSL) transformations (XSLT) may provide strict inspection and analytics of replication data at various granularities such as an individual transaction file, database transaction, LOB, or row or column of a database table. For example herein, a LOB is not opaque and can be parsed, scrutinized, and modified in a structured way.

Additional metadata describing what in-flight data was cleansed is generated and inserted into the replication stream so that the target database can maintain transactional integrity aspects such as exactly-once and correctly-ordered DML with referential integrity. While the replication data is in flight, the content filter may apply various actions such as cleansing, enriching, filtering, and anonymizing data. A user may define reactions for the system to take, including applying changes to the target database, discarding unsafe or otherwise inappropriate data, writing alerts to exception tables, and reporting inconsistent transactions. As discussed in the above Background, leakage of sensitive information, which is quantitatively measurable, is prevented by this approach. That prevention empirically increases the reliability and data integrity of the computers herein and, in those ways, this approach increases the privacy and security of the computer itself.

Due to the asynchronous way of batch file transfer herein, the degree of decoupling the target database from the source database is increased. For example although near real-time continuous replication transmission is supported, an implementation may instead operate with unexpected or scheduled connectivity outages. A key feature of this decoupled approach is that the source database and the target database may be operated at very different respective degrees of security without compromising transactional integrity.

### 1.0 Example Distributed System

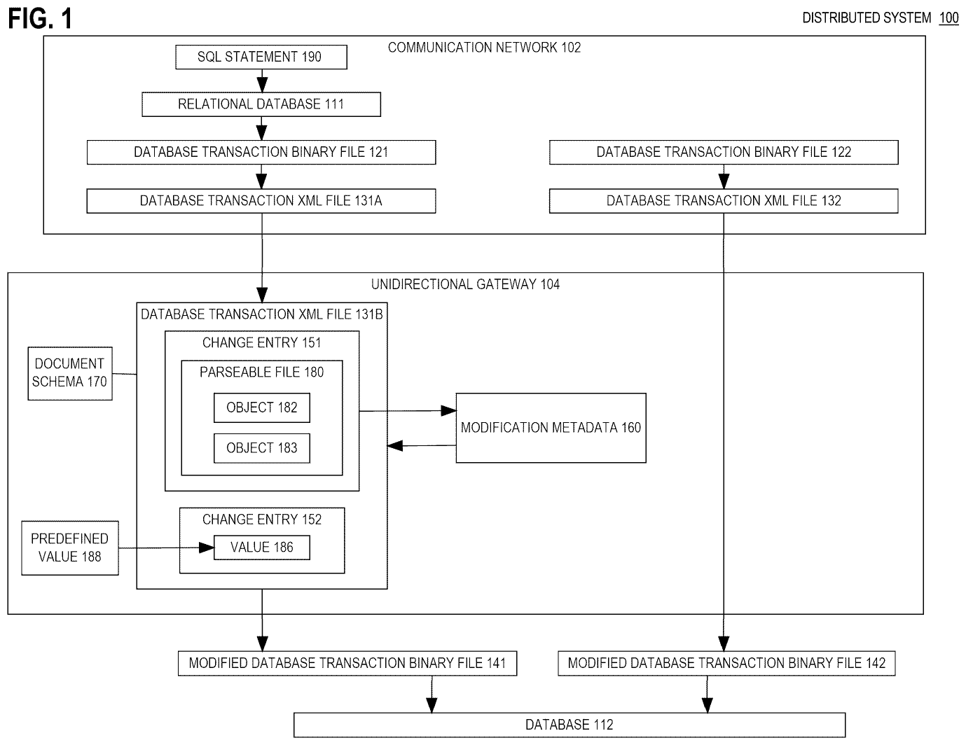

FIG. 1 is a block diagram that depicts example distributed system 100 that may, for example, synchronize databases 111-112. For consistency and security, unidirectional gateway 104 modifies and annotates a sequence of database transaction extensible markup language (XML) files 131A and 132 that are received from communication network 102. Distributed system 100 additionally contains a secure communication network (not shown) that contains and is externally accessible only through unidirectional gateway 104. Each of the secure communication network and communication network 102 contains one or more computers such as a rack server such as a blade, a mainframe, a virtual machine, or other computing device. Each of the secure communication network and communication network 102 may be a wide area network (WAN) or a local area network (LAN) such as ethernet.

### 1.1 Unidirectional Gateway

Unidirectional gateway 104 operates as a network firewall that never externally sends data from the secure communication network. For example, unidirectional gateway 104 never sends data to communication network 102, which is why only vertical arrows pointing downwards enter or exit unidirectional gateway 104. Depending on the embodiment, unidirectional gateway 104 may have a hardware or software implementation.

In a first example hardware implementation, unidirectional gateway 104 is connected to communication network 102 by optic cable, but only communication network 102 contains an optic transmitter. In a second example hardware implementation, unidirectional gateway 104 contains a so-called air-gap dataflow controller that contains a microchip that electronically enforces one-way transmission.

In another example implementation, unidirectional gateway 104 may be a combination of: a) software that enforces one-way transmission and b) any network element that can operate as a network firewall. In some hardware or software implementations, unidirectional gateway 104 may send network protocol metadata to communication network 102 to facilitate transfer of database transaction XML files 131-132 from communication network 102 to unidirectional gateway 104.

### 1.2 Database Transaction File

Shown database transaction XML file 131A is database transaction XML file 131 (not shown) as originally received, after which database transaction XML file 131 will be modified by unidirectional gateway 104 for consistency and security, shown as database transaction XML file 131B. However, shown data components 151-152, 180, 182-183, and 186 are identical in database transaction XML files 131A-B at least until unidirectional gateway 104 performs modifications discussed later herein. Database transaction files 121-122, 131-132, and 141-142 are discussed later herein.

### 1.3 Database Technology

Relational database 111 is a source database that may, for example, be logically replicated to target database 112 that may or may not be a relational database. In operation, relational database 111 executes many various structured query language (SQL) statements such as data manipulation language (DML) that changes content values in relational table(s) (not shown) in relational database 111. For example, relational database 111 may be operated by a relational database management system (RDBMS) (not shown) that can perform online transaction processing (OLTP). SQL statement 190 may be a DML statement or, in some examples, a data definition language (DDL) statement that modifies the relational schema of relational database 111. Relational database architecture is discussed later herein.

With relational database 111, one or more SQL statements may be executed in a database transaction (not shown) such as an atomic, consistent, isolated, durable (ACID) transaction. A transaction may make many changes to relational database 111. For example, relational database 111 may contain a relational table that contains many rows and columns, and SQL statement 190 may write new values into many rows, many columns, and many tables. Each column has a respective datatype that may, for example, be a scalar such as text (i.e. a character string) or a number.

### 1.4 Change Entries

Values written into relational database 111 by transactions are described by change entries. In an embodiment, SQL statement 190 may write many values, many rows, and many columns. In an embodiment, a data cell contains one scalar value in a relational table at the intersection of one row and one column. In an embodiment, a separate change entry is generated for each data cell written. For example, writing a same value into two columns in a same row may entail two change entries. Likewise, writing a same value into two rows in a same column may entail two change entries. Likewise, writing two distinct values in sequence into a same data cell may entail two change entries. A change entry may record any fine-grained change that may occur by create, read, update, delete (CRUD) activity by SQL statement 190.

A sequence of multiple change entries by one or more SQL statements in one or more transactions that were applied to relational database 111 are persisted in database transaction binary file 121 that is not a text file. Database transaction binary file 121 is converted to database transaction XML file 131A that is a parseable (i.e. well formed) text file such as XML or JavaScript object notation (JSON). In an embodiment, the sequence of change entries in a database transaction XML file are stored as a one-dimensional array of change entries. Despite having different respective encoding formats, database transaction files 121 and 131A are logically equivalent.

In one scenario, change entries 151-152 are caused by execution of SQL statement 190. In another scenario, change entries 151-152 are caused by execution of separate respective SQL statements in a same transaction. In another scenario, change entries 151-152 are caused by separate respective transactions.

### 1.5 XML Processing

Database transaction XML file 131A is received and processed by unidirectional gateway 104, shown as database transaction XML file 131B that unidirectional gateway 104 may process and modify. In an embodiment, unidirectional gateway 104 contains a document parser such as an XML parser that parses database transaction XML file 131B. In an embodiment, the document parser performs schema validation. For example, unidirectional gateway 104 may validate database transaction XML file 131B with document schema 170 and raise an alert or exception if validation fails. In an embodiment, document schema 170 is itself an XML document such as an extensible schema definition (XSD).

In an embodiment, the XML parser generates an abstract syntax tree (AST) that is a document object model (DOM) that represents database transaction XML file 131B in a structured format in random access memory (RAM), and unidirectional gateway 104 can analyze and modify the DOM. Unidirectional gateway 104 analyzes each of change entries 151-152 to decide which change entry(s) should be modified and which change entries should not be modified. In this example, unidirectional gateway 104 modifies both change entries 151-152 in distinct respective ways as follows.

### 1.6 Cleansing of Data in Flight

Change entry 152 contains sensitive value 186 that is unacceptable, which unidirectional gateway 104 detects. For example, value 186 may be personally identifiable information (PII) that is forbidden to be used except within communication network 102. In one example, source relational database 111 contains value 186, but target database 112 never should. In an embodiment, unidirectional gateway 104 modifies change entry 152 by replacing (i.e. overwriting) value 186 with predefined value 188. In an embodiment, predefined value 188 consists of a same predefined character repeated, such as an asterisk. In an embodiment, predefined value 188 has a same or different length (i.e. character count) than value 186. In those ways, unidirectional gateway 104 may redact sensitive values.

A value in a data cell or in a change entry may be scalar or compound. In an embodiment, a compound value may be a large object (LOB) such as a binary LOB (BLOB) or character LOB (CLOB). In an embodiment, a LOB may be a file or an attachment such as a multipurpose internet mail extension (MIME). In the shown example, unidirectional gateway 104 uses a parser to detect that parseable file 180 contains objects 182-183. For example, parseable file 180 may be a BLOB that is a portable document file (PDF) that unidirectional gateway 104 can parse. In the shown embodiment, change entry 151 actually contains parseable file 180. In another embodiment: a) parseable file 180 is a separately stored file that database transaction XML file 131B does not contain, and b) change entry 151 contains a reference to parseable file 180. Unidirectional gateway 104 can receive and modify parseable file 180 as follows. For example, unidirectional gateway 104 may detect that object 182 is unsafe and delete object 182 without deleting components 180 and 183.

In those ways, unidirectional gateway 104 makes respective modifications to change entries 151-152. In an embodiment, unidirectional gateway 104 further modifies database transaction XML file 131B by generating and inserting, into database transaction XML file 131B, respective modification metadata that describes the modifications to change entries 151-152. For example, modification metadata 160 may indicate either or both of: a) object 182 was deleted, and b) why object 182 was deleted. Although not shown, another modification metadata may describe replacement of value 186.

### 1.7 Internetworking Topology

Distributed system contains communication network 102 and a secure network (not shown) that contains unidirectional gateway 104 that operates as a network gateway between both networks. Although not shown, each of the two networks may contain multiple computers. Discussion elsewhere herein may regard an exemplary embodiment that contains five computers that are: 1) a source computer that hosts relational database 111, 2) an encoder computer that generates and sends database transaction XML files 131A and 132, 3) a guard computer that hosts unidirectional gateway 104, 4) a decoder computer that generates modified database transaction binary files 141-142 as follows, and 5) a target computer that hosts database 112. In that case, communication network 102 contains the source computer and the encoder computer, and the secure network contains the guard computer, the decoder computer, and the target computer. In various embodiments, some of those five computers may be combined into a same computer so long as the computers being combined are in a same one of the two networks. The three computers in the secure network may cooperate as follows.

### 1.8 Lifecycle of Database Transaction File

Unidirectional gateway 104 modifies database transaction XML file 131B that is subsequently converted by the decoder computer to modified database transaction binary file 141 that is not a text file. In an embodiment, each of database transaction binary files 121-122 and 141-142 is an Oracle GoldenGate trail file, and modification metadata 160 is converted into an annotation such as a GoldenGate token in modified database transaction binary file 141. In an embodiment, database transaction XML files 131A-B may contain GoldenGate tokens that unidirectional gateway 104 can analyze, modify, or delete. In an embodiment, generation of database transaction XML file 131A causes generation or modification of attributes such as GoldenGate tokens. For example, database transaction files 121 and 131A-B are three files that are more or less logically identical but may contain distinct respective sets of attributes such as GoldenGate tokens.

Various embodiments do or do not include database 112 that may, for example, be a relational database or a NoSQL database. Instead of database 112, an embodiment may have a persistent datastore such as Hadoop or a more or less continuous data stream such as Kafka. Modified database transaction binary file 141 may be applied to any such database, datastore, or data stream. For example, database 112 may be a replica that is synchronized from relational database 111 by applying modified database transaction binary files 141-142.

For example, a sequence of transactions applied to relational database 111 may entail a sequence of change entries that includes a first subsequence of change entries followed by a second subsequence of change entries. For example, the first and second subsequences of change entries may respectively be contained in database transaction binary files 121-122 that may be GoldenGate trail files for which unidirectional gateway 104 and the decoder computer cooperate to generate respective modified database transaction binary files 141-142.

### 1.9 Transactional Integrity

The decoder computer may asynchronously (e.g. concurrently) generate modified database transaction binary files 141-142 for respective database transaction XML files 131A and 132 and, for example, it may be nondeterministic as to generation of which of modified database transaction binary files 141-142 completes first. For example, database transaction XML file 131A may contain more change entries or more or larger LOBs than database transaction XML file 132. If database transaction binary file 121 was generated before database transaction binary file 122 then, for transactional consistency (e.g. ACID), modified database transaction binary file 141 should be applied to database 112 before modified database transaction binary file 142, even if generation of modified database transaction binary file 142 finished before generation of modified database transaction binary file 141. For example, database transaction binary files 121-122 may contain timestamps or serial numbers (e.g. system change number, SCN) that indicate that database transaction binary file 121 contains changes that are older than the changes in database transaction binary file 122. In an embodiment, if generation of modified database transaction binary file 142 finishes before database transaction XML file 131A is successfully sent to unidirectional gateway 104, then unidirectional gateway 104 may detect a gap in, for example, SCNs and wait for database transaction XML file 131A to be received and processed to fill that gap.

### 2.0 Example High Security Process for Database Replication

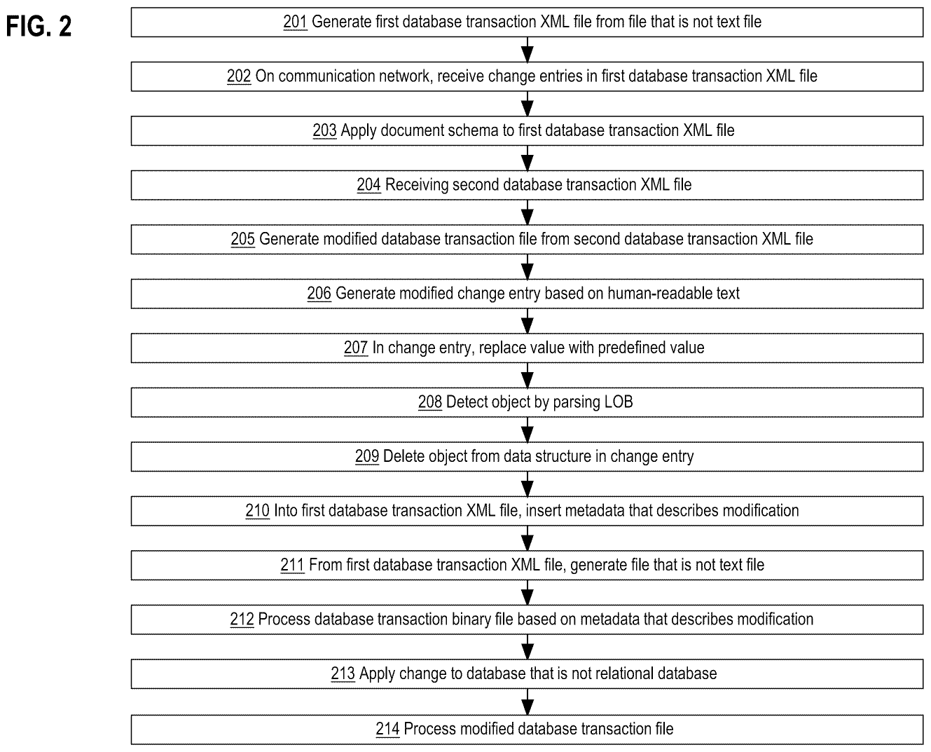

FIG. 2 is a flow diagram that depicts an example process that distributed system 100 may perform, for consistency and security, to modify and annotate a sequence of database transaction extensible markup language (XML) files 131A and 132 that are received from communication network 102. As discussed earlier herein, distributed system 100 may consist of communication network 102 and a secure network that interoperate as follows.

In the exemplary embodiment discussed earlier herein, communication network 102 contains a source computer and an encoder computer, and the secure network contains a guard computer that contains unidirectional gateway 104, a decoder computer, and a target computer. In an embodiment, step 201 is performed by the encoder computer. In an embodiment, steps 202-204 and 206-210 are performed by unidirectional gateway 104. In an embodiment, unidirectional gateway 104 and the decoder computer cooperatively perform step 205, and the decoder computer performs step 211. In an embodiment, the decoder computer and the target computer cooperatively perform steps 212-214.

Thus, distributed system 100 may have substantial asynchrony and concurrency. In other words, steps 201-214 are performed in the shown ordering in some scenarios and, in other scenarios, performed in a somewhat different ordering. In some scenarios or embodiments, only some but not all of steps 201-214 are performed or implemented.

Database transaction XML files 131-132 may respectively be referred to herein as a first database transaction XML file and a second database transaction XML file. Step 201 generates first database transaction XML file 131A from database transaction binary file 121 that is not a text file, as discussed earlier herein. In various configurable embodiments, step 201 may be responsive to any of: a) expiration of a timer that was set by the previous occurrence of step 201, or b) database transaction binary file 121 exceeding a threshold size in bytes, change entries, or transactions.

On communication network 102, step 202 receives change entries 151-152 in first database transaction XML file 131A as discussed earlier herein. Database transaction XML file 131 is variously shown in FIG. 1 as database transaction XML files 131A-B that initially are identical until step 205 as discussed herein. For validation or parsing, step 203 applies document schema 170 to database transaction XML file 131B as discussed earlier herein.

Database transaction binary file 121 is older and contains older change entries than database transaction binary file 122 but, as discussed earlier herein, the lifecycle of database transaction binary file 122 might pass (i.e. race ahead of) database transaction binary file 121 as follows. In step 204, unidirectional gateway 104 receives second database transaction XML file 132. As discussed earlier herein, database transaction XML files 131-132 may contain different respective amounts of change entries of various sizes and complexity. For example, step 205 may generate modified database transaction binary file 142 from database transaction XML file 132 while generation of modified database transaction binary file 141 by steps 206-211 is ongoing as follows.

In database transaction XML file 131, original change entries 151-152 are respectively specified as XML that is human-readable text from which step 206 respectively modifies (i.e. generates modified) change entries 151-152 as follows. Steps 207-210 may be sub-steps of step 206. In change entry 152, step 207 replaces value 186 with predefined value 188 as discussed earlier herein.

Step 208 detects object 182 by parsing parseable file 180 that may be a large object (LOB) that contains a data structure that contains objects 182-183 as discussed earlier herein. For example, step 208 may analyze object 182 to detect that object 182 is malicious or otherwise unsafe and, responsively, step 209 deletes object 182 from the data structure in parseable file 180. Into database transaction XML file 131B, step 210 generates and inserts modification metadata 160 that describes, for example, the deletion of object 182, and step 210 may generate and insert other modification metadata that describes other modifications to other change entries in database transaction XML file 131B.

From database transaction XML file 131B, step 211 generates modified database transaction binary file 141 that is not a text file. Even though other modified database transaction binary file 142 already was generated by above step 205, the process of FIG. 2 may defer processing of modified database transaction binary file 142 until later for transactional consistency as discussed earlier herein.

Step 212 processes modified database transaction binary file 141 based on modification metadata 160 that was stored by unidirectional gateway 104 into modified database transaction binary file 141 as an annotation such as a GoldenGate token. In an embodiment, step 212 entails step 213 as a sub-step that applies change entries 151-152 to database 112.

In an embodiment: a) database 112 is a relational database and parseable file 180 is a value in a data cell in a relational table as discussed earlier herein, and b) the relational table has additional rows in database 112 that store previous versions of rows, and relational database 111 does not retain those previous versions. The following is a cooperative example of steps 212-213.

In this cooperative example, that relational table contains: a) in both databases 111-112, a BLOB column that stores parseable file 180 and b) only in database 112, an additional column that indicates whether or not parseable file 180 has become inconsistent (e.g. object 182 is deleted as unsafe). In this cooperative example, step 212 detects that modification metadata 160 indicates that object 182 was deleted and, before generating modified database transaction binary file 141, step 212 responsively generates and inserts an additional change entry (not shown) into database transaction XML file 131B that changes that additional column in the current version row to indicate that parseable file 180 has become inconsistent. In this cooperative example, step 213 generates a version row in the relational table in database 112 that is a retained copy of the current version row and then applies change entries 151-152 and that additional change entry to the current version row. For example: a) a retained previous version of object 182 may be safe, and b) a client of database 112 may retrieve that safe version of object 182 from a retained previous version row even though the current version row does not contain object 182 that was deleted as unsafe.

As discussed earlier herein, even though modified database transaction binary file 142 already was generated by above step 205, the process of FIG. 2 may, for transactional consistency, defer processing of modified database transaction binary file 142 until step 213 has applied modified database transaction binary file 141 to database 112, after which step 214 applies modified database transaction binary file 142 to database 112.

### 3.0 Database System Overview

A database management system (DBMS) manages one or more databases. A DBMS may comprise one or more database servers. A database comprises database data and a database dictionary that are stored on a persistent memory mechanism, such as a set of hard disks. Database data may be stored in one or more data containers. Each container contains records. The data within each record is organized into one or more fields. In relational DBMSs, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database command may be in the form of a database statement that conforms to a database language. A database language for expressing the database commands is the Structured Query Language (SQL). There are many different versions of SQL, some versions are standard and some proprietary, and there are a variety of extensions. Data definition language (“DDL”) commands are issued to a database server to create or configure database objects, such as tables, views, or complex data types. SQL/XML is a common extension of SQL used when manipulating XML data in an object-relational database.

A multi-node database management system is made up of interconnected nodes that share access to the same database or databases. Typically, the nodes are interconnected via a network and share access, in varying degrees, to shared storage, e.g. shared access to a set of disk drives and data blocks stored thereon. The varying degrees of shared access between the nodes may include shared nothing, shared everything, exclusive access to database partitions by node, or some combination thereof. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

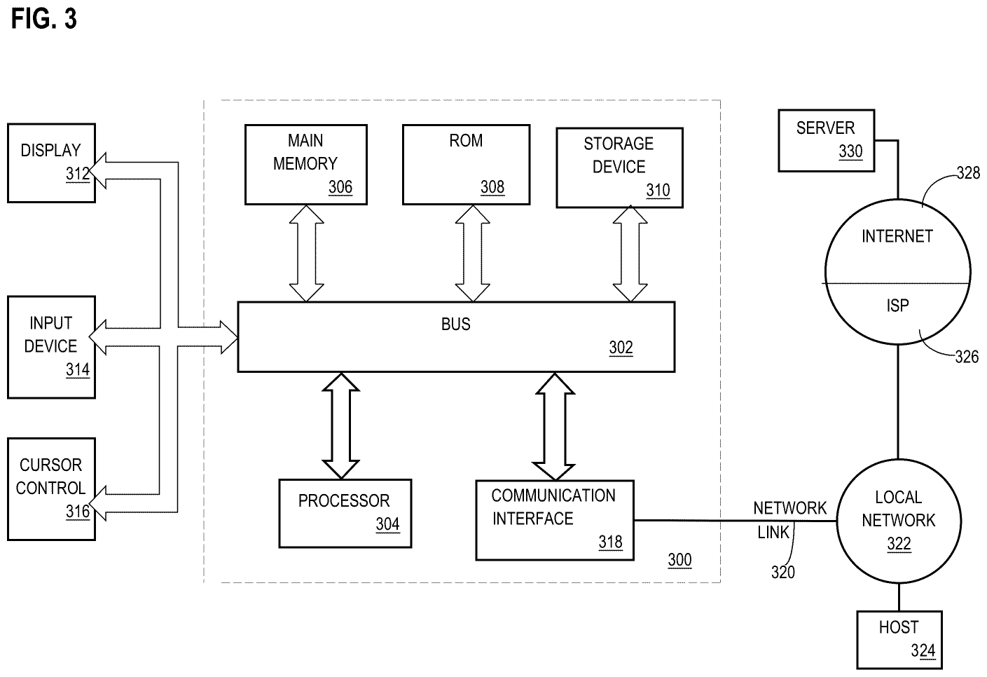

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

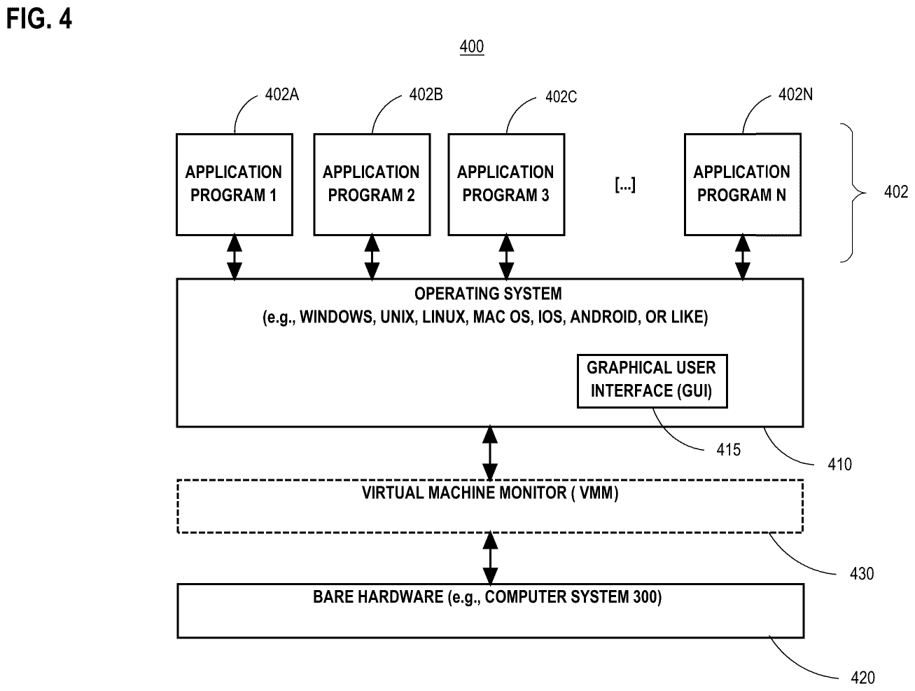

FIG. 4 is a block diagram of a basic software system 400 that may be employed for controlling the operation of computing system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 400 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
receiving, by a unidirectional gateway, a plurality of change entries in a database transaction text file;
modifying a change entry in the plurality of change entries;
inserting, into the database transaction text file, metadata that describes said modifying; and
processing the database transaction file based on the metadata that describes said modifying.

2. The method of claim 1 wherein:
the change entry is human-readable text;
said modifying comprises generating a modified change entry based on the human-readable text.

3. (canceled)

4. The method of claim 1 further comprising generating the database transaction text file from a file that is not a text file.

5. The method of claim 1 further comprising generating a file that is not a text file from the database transaction text file.

6. The method of claim 1 wherein:
the change entry comprises a data structure that contains an object;
said modifying comprises deleting the object from the data structure.

7. The method of claim 6 wherein:
the data structure is a large object (LOB);
the method further comprises detecting the object by parsing the LOB.

8. The method of claim 1 wherein:
the change entry represents a change in a relational database;
the method further comprises applying the change to a database that is not a relational database.

9. The method of claim 1 wherein:
the database transaction text file is a first database transaction file;
said modifying is a first modifying;
the method further comprises:
receiving a second plurality of change entries in a second database transaction file after said receiving the first database transaction file,
second modifying a change entry in the second plurality of change entries;
inserting, into the second database transaction file, second metadata that describes said second modifying; and
processing, before said processing the first database transaction file, the second database transaction file based on the second metadata that describes said second modifying.

10. The method of claim 1 further comprising applying a document schema to the database transaction text file.

11. The method of claim 1 wherein said modifying comprises replacing, in the change entry, a value with a predefined value.

12. The method of claim 1 wherein the change entry represents a change caused by a data definition language (DDL) statement.

13. The method of claim 1 wherein the unidirectional gateway performs said modifying and said inserting.

14. One or more non-transitory computer-readable media storing instructions that, when executed by one or more processors, cause:
receiving, by a unidirectional gateway, a plurality of change entries in a database transaction text file;
modifying a change entry in the plurality of change entries;
inserting, into the database transaction text file, metadata that describes said modifying; and
processing the database transaction file based on the metadata that describes said modifying.

15. The one or more non-transitory computer-readable media of claim 14 wherein:
the change entry is human-readable text;
said modifying comprises generating a modified change entry based on the human-readable text.

16. (canceled)

17. The one or more non-transitory computer-readable media of claim 14 wherein:
the change entry comprises a data structure that contains an object;
said modifying comprises deleting the object from the data structure.

18. The one or more non-transitory computer-readable media of claim 14 wherein:
the change entry represents a change in a relational database;
the instructions further cause applying the change to a database that is not a relational database.

19. The one or more non-transitory computer-readable media of claim 14 wherein:
the database transaction text file is a first database transaction file;
said modifying is a first modifying;
the instructions further cause:
receiving a second plurality of change entries in a second database transaction file after said receiving the first database transaction file,
second modifying a change entry in the second plurality of change entries;
inserting, into the second database transaction file, second metadata that describes said second modifying; and
processing, before said processing the first database transaction file, the second database transaction file based on the second metadata that describes said second modifying.

20. The one or more non-transitory computer-readable media of claim 14 wherein the instructions further cause applying a document schema to the database transaction text file.

21. The one or more non-transitory computer-readable media of claim 14 wherein the instructions cause the unidirectional gateway to perform said modifying and said inserting.
